(19) United States
(12) Patent Application Publication
(10) Pub. No.: US 2006/0071379 A1
(43) Pub. Date: Apr. 6, 2006

(54) Liquid-sealed vibration control device

(76) Inventors: Akihiko Kato, Osaka (JP); Kazuhiro Ito, Osaka (JP)

Correspondence Address: JORDAN AND HAMBURG LLP, 122 EAST 42ND STREET, SUITE 4000, NEW YORK, NY, 10168, US

(21) Appl. No.: 10/496,479

(22) PCT Filed: Sep. 19, 2003
(86) PCT No.: PCT/JP03/12067

§ 371 Date: Jul. 26, 2004

(30) Foreign Application Priority Data
Apr. 21, 2003 (JP) 20039115162

(51) Int. Cl. F16F 9/00

(52) U.S. Cl. 267/140.11

(57) ABSTRACT

One pair of first rubber-like elastomer bodies (27) are interposed between an inner cylinder (1) and an intermediate cylinder (4); one pair of second rubber-like elastomer bodies (37) are interposed between the intermediate cylinder (4) outside the first rubber-like elastomer bodies (27) and an outer cylinder (2); and one pair of liquid chambers (5) and an orifice (6) are formed between the intermediate cylinder (4) and the outer cylinder (2). Further, end walls of the liquid chambers (5) are formed as rubber walls (12); third rubber-like elastomer bodies (11) shorter in length are interposed between the intermediate cylinder (4) on the rear side of the liquid chambers (5) and the inner cylinder (1); and one pair of inclination amount-limiting stoppers (16) for limiting the inclination amount of the outer cylinder (2) to the intermediate cylinder (4) are provided respectively separately between one end of the outer cylinder (2) and one end of the intermediate cylinder, and between the other end of the outer cylinder (2) and the other end of the intermediate cylinder.

### TECHNICAL FIELD

This invention relates to a liquid-sealed type vibration-proof device.

### BACKGROUND ART

A liquid-sealed type of vibration-proof device is generally constructed by interposing a rubber-like elastomer between an inner cylinder and an outer cylinder, providing one pair of liquid chambers and an orifice bringing both liquid chambers into communication with each other between the inner and outer cylinders, and forming end walls of the liquid chambers relative to a central axis direction of the inner and outer cylinders as rubber walls susceptible of expansion and compression concomitantly with relative displacement of the inner and outer cylinders. For example, it is installed between a suspension and a lower arm of automobiles.

And its excellent vibration-damping effect is achieved owing to such a liquid fluidization effect that when vibrations input, the inner cylinder and the outer cylinder are displaced relatively, the rubber-like elastomer and the rubber walls are deformed elastically, volumes of both liquid chambers are changed, thereby the liquid flows through the orifice.

Hitherto in the aforementioned vibration-proof device as illustrated in FIG. 6, rubber walls 12 have been vulcanization-formed to extend over an inner cylinder 1 and a fit cylinder 8 internally fitted in an outer cylinder 2. The reference numeral 5 designates a liquid chamber and the reference numeral 6, an orifice. Such a construction is also disclosed in JP Patent Application Publication 2003-83389A.

### DISCLOSURE OF INVENTION

According to the foregoing conventional construction, because of the fact that the rubber walls 12 were vulcanization-formed to extend over the inner cylinder 1 and the fit cylinder 8 internally fitted in the outer cylinder 2, the rubber walls 12 were subjected to a tensile force and a compression force of a magnitude corresponding to an inclination angle made by the inner cylinder 1 and the outer cylinder 2. In particular, when the outer cylinder 2 was tilted at a largest degree against the inner cylinder 1, the one rubber wall 12 being compressed was buckled in the vicinity of its root portion as illustrated in FIG. 7, and cracking was likely to occur in that portion by repeated buckling.

An object of this invention is to provide a liquid-sealed vibration-proof device, with which it is possible to lengthen the lifetime of the rubber walls constituting end walls of liquid chambers.

Features of this invention reside in that one pair of first rubber-like elastomer bodies situated to pinch an inner cylinder between them are interposed between the inner cylinder and an intermediate cylinder, one pair of second rubber-like elastomer bodies situated to pinch the intermediate cylinder between them are interposed between the intermediate cylinder, which is outside of the first rubber-like elastomer bodies, and the outer cylinder; that between the intermediate cylinder and the outer cylinder, that are formed one pair of liquid chambers and an orifice bringing both liquid chambers into communication with each other that are disposed, pinching the intermediate cylinder in different directions from the one pair of the second rubber-like elastomer bodies; that end walls of the liquid chambers relative to a central axis direction of the inner and outer cylinders are formed as rubber walls susceptible of expansion and compression accompanied with relative displacement of the intermediate cylinder and the outer cylinder, that between the intermediate cylinder and the inner cylinder on the backside of the one liquid chamber, and between the intermediate cylinder and the inner cylinder on the backside of the other liquid chamber, there are interposed respective third rubber-like elastomer bodies that are shorter in length in the central axis direction than the first rubber-like elastomer bodies and the second rubber-like elastomer bodies; that at least one pair of inclination amount limiting stoppers for limiting an inclination amount of the outer cylinder to the intermediate cylinder are provided respectively between one end portion of the outer cylinder outwards of the liquid chamber and one end portion of the intermediate cylinder, and between the other end portion of the outer cylinder and the other end portion of the intermediate cylinder.

According to the aforesaid construction, when vibrations input, the inner cylinder and the outer cylinder are displaced relatively, concurrently with which the intermediate cylinder and the outer cylinder are displaced relatively, and the first and the second rubber-like elastomer bodies and the rubber walls are deformed elastically. As a result, the volumes of the pair of the liquid chambers are changed and the liquid flows through the orifice to dampen the vibrations.

When the inner cylinder and the outer cylinder are slanted by the elastic deformation mentioned above, the rubber walls are subjected to a tensile force and a compressive force of a magnitude corresponding to an inclination angle made by the intermediate cylinder and the outer cylinder. Since a maximum value of this inclination angle is smaller than a maximum value of an inclination angle of the inner cylinder and the outer cylinder, the tensile force and the compressive force applied to the rubber walls can be made smaller. Further, the inclination amount of the outer cylinder to the intermediate cylinder can be limited by means of the inclination amount-limiting stoppers, and consequently, it is possible to prevent the tensile force and the compressive force applied to the rubber walls from surpassing a predetermined magnitude.

With such a construction that the inner cylinder and the intermediate cylinder are hard to slant, the inclination angle of the intermediate cylinder and the outer cylinder is larger, so that the frequency of limiting the inclination amount by the action of the inclination amount-limiting stoppers will be increased. In contrast, according to the aforesaid construction of the invention, the length of the third rubber-like elastomer bodies in the central axis direction is made shorter than those of the fist rubber-like elastomer bodies and the second rubber-like elastomer bodies, and the inner cylinder and the intermediate cylinder are easy to slant in a radial direction in which the pair of liquid chambers are juxtaposed. Accordingly, it is possible to suppress the inclination angle of the intermediate cylinder and the outer cylinder from increasing and to diminish the frequency in which the inclination amount limiting stoppers act.

As a result, it is possible to diminish the frequency in which the inclination angle of the intermediate cylinder and the outer cylinder reaches a maximum inclination amount, to diminish the burden exerted on the rubber walls between the intermediate cylinder and the outer cylinder, and to diminish the frequency of impact when the inclination amount-limiting stoppers act, whereby the durability can be enhanced.

Further because of the inclination amount limiting stoppers outside the liquid chambers, the volumes of the liquid chambers are in no way reduced. Moreover because at least one pair of the inclination amount limiting stoppers are disposed respectively separately between one end portion of the outer cylinder and one end portion of the intermediate cylinder, and between the other end portion of the outer cylinder and the other end portion of the intermediate cylinder, they can cope with any slanting in the normal and reverse directions.

In the radial direction in which one pair of the first rubber-like elastomer bodies and one pair of the second rubber-like elastomer bodies are juxtaposed, spring constants of them can be made larger. This is advantageous in cases where it is wished to vary spring constants in two mutually intersecting directions (e.g., a vertical direction and a lateral direction of a vehicle, a fore-and-aft direction and a lateral direction of a vehicle).

In the construction that the second rubber-like elastomer bodies and the rubber walls are vulcanization-formed to extend over the intermediate cylinder and the fit cylinder to the outer cylinder, with the fit cylinder internally fitted in the outer cylinder, the filling of a liquid into the liquid chambers is facilitated. That is, the expedient for sealing the liquid into the liquid chambers can be realized by conducting a crimping working of the outer cylinder having the fit cylinder fitted in the liquid.

In a case where one pair of the aforesaid inclination amount-limiting stoppers are provided respectively separately at both ends of the intermediate cylinder so as to be spaced apart a predetermined distance from an inner peripheral part of the outer cylinder or an inner peripheral part of the fit cylinder, such a trouble can be avoided that the inclination amount-limiting stoppers might protrude radially outwardly beyond the outer cylinder and consequently, the construction can be compactified.

### BRIEF DESCRIPTION OF DRAWINGS

FIG. 1 is a plan view of a liquid-sealed type vibration-proof device;

FIG. 2 is a sectional view taken along C-O-C line of FIG. 1;

FIG. 3 is a front elevation of a liquid-sealed type vibration-proof device;

FIG. 4 is a sectional view taken along D-D line of FIG. 3;

FIG. 5 is a longitudinal sectional view showing a tilting state of the outer cylinder relative to the inner cylinder;

FIG. 6 is a longitudinal sectional view of a conventional liquid-sealed vibration-proof device; and

FIG. 7 is a longitudinal sectional view of the conventional device showing a tilting state of the outer cylinder to the inner cylinder.

### BEST MODE FOR CARRYING OUT THE INVENTION

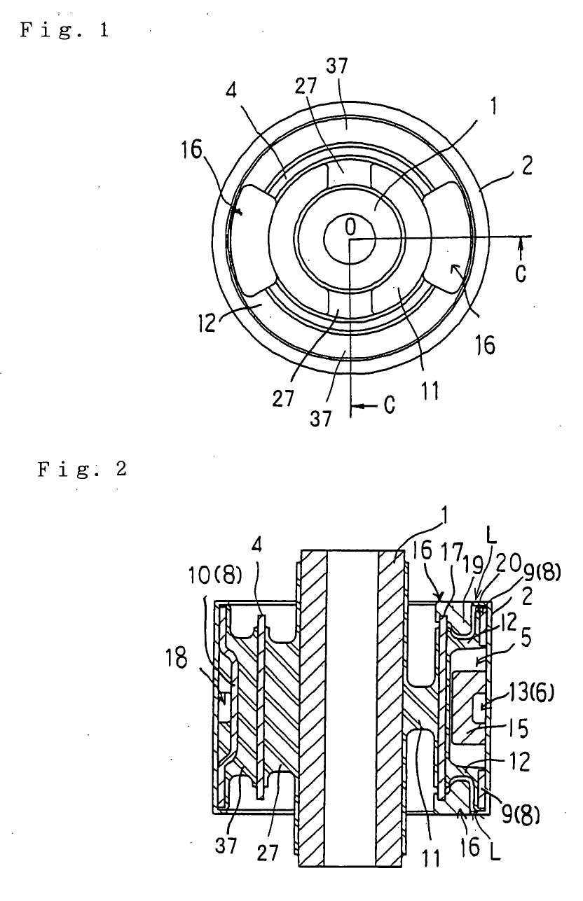

Embodiments of the invention will be hereinafter described with reference to the drawings. Of one pair of front and rear vibration-proof devices installed between a front suspension member and a lower arm (both not shown) of an automobile, FIGS. 1 and 2 illustrate the rear liquid-sealed vibration-proof device of a longitudinal mounting type.

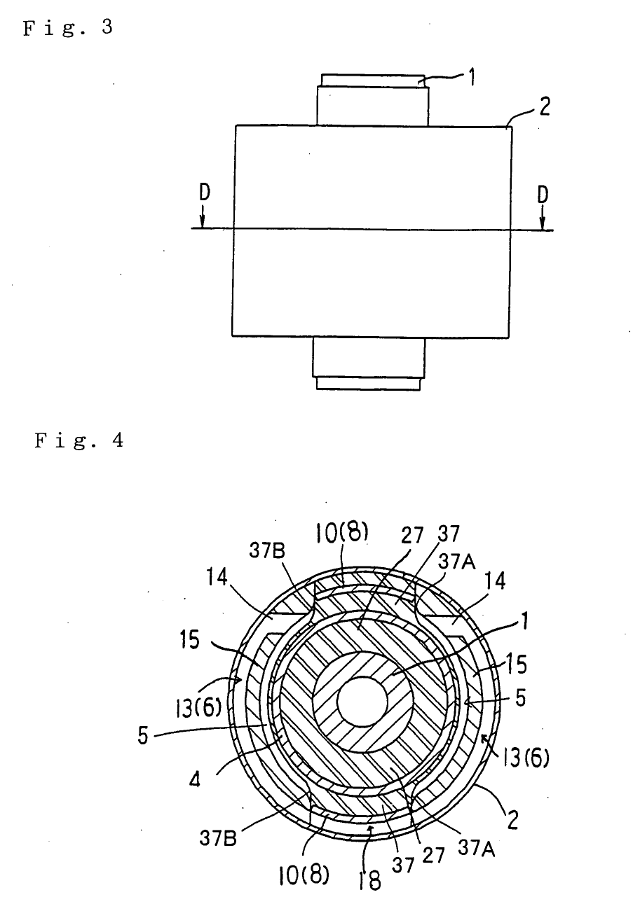

The liquid-sealed vibration-proof device is constructed, as also shown in FIGS. 3 and 4, by interposing one pair of first rubber-like elastomer bodies 27 that are situated to pinch an inner cylinder 1 between them, between the thick-walled inner cylinder 1 and a thin-walled intermediate cylinder 4; interposing one pair of second rubber-like elastomer bodies 37 situated to pinch the intermediate cylinder 4 between them, between the intermediate cylinder 4 outside the first rubber-like elastomer body 27 and an outer cylinder 2; forming one pair of liquid chambers 5 and an orifice 6 bringing both liquid chambers 5 into communication with each other, which are situated to pinch the intermediate cylinder 4 in different directions from the pair of second rubber-like elastomer bodies 37, between the intermediate cylinder 4 and the outer cylinder 2. And the device is press fitted into a longitudinal collar on the lower arm side and fastened to a suspension member with a fitting bolt inserted through the inner cylinder 1.

The inner cylinder 1, the outer cylinder 2 and the intermediate cylinder 4 assume a cylindrical shape, and the intermediate cylinder 4 is situated nearly in the middle between the inner and outer cylinders 1, 2. As shown in FIG. 4, the first rubber-like elastomer bodies 27 are vulcanization formed to extend over an outer periphery of the inner cylinder 1 and an inner periphery of the intermediate cylinder 4 whereas the second rubber-like elastomer bodies 37 are vulcanization formed so as to extend over an outer periphery of the intermediate cylinder 4 and an inner periphery of a fit cylinder 8 internally fitted in the outer cylinder 2. The longitudinal sectional contour of each first rubber-like elastomer body 27 (sectional shape as viewed from radially outward of the inner and outer cylinders 1, 2) and the longitudinal sectional contour of each second rubber-like elastomer body 37 are identical, and the lengths of the inner and outer cylinders 1, 2 in the central axis direction are equal (this invention is also applicable to such a construction that the longitudinal sectional configurations of both cylinders are different or lengths of both in the central axis direction are different).

The fit cylinder 8 is comprised of one pair of round ring portions 9 that are in press contact with the outer cylinder 2 and located at both ends in the central axis direction and one pair of mutually opposing longitudinal walls 10 connecting both ring portions 9 to each other, both longitudinal walls 10 opening circumferentially between them.

The second rubber-like elastomer bodies 37 are vulcanization bonded to the longitudinal walls 10. The pair of the longitudinal walls 10 are situated slightly on the axis center side of the inner and outer cylinders 1, 2 a both ring portions 9, and between rear faces of the longitudinal walls 10 and the outer cylinder 2, there is formed a passage 18, on the longitudinal walls side, that communicates with an orifice channel 13, which will be later described. A rubber-like elastomer is vulcanization-formed also on the rear face sides of the longitudinal walls 10, and the sidewall of the passage 18 on the longitudinal walls side is formed of this rubber-like elastomer, accordingly (such a structure is also possible that the sidewall of the passage 18 on the longitudinal walls side is not formed of the rubber-like elastomer, for example, a structure that the side wall is formed only of an orifice-forming member 15).

One pair of membrane-like rubber walls 12 that are end walls relative to the central axis direction of the inner and outer cylinders 1, 2 cover in the circumferential direction of the inner and outer cylinders 1, 2 between sidewalls 37A of one pair of the second rubber-like elastomer bodies 37. The one liquid chamber 5 is formed in this way. The pair of the membrane-like rubber walls 12 that are end walls relative to the central axis direction of the inner and outer cylinders 1, 2 cover similarly between other sidewalls 37B of the pair of the second rubber-like elastomer bodies 37. In this way the other liquid chamber 5 is formed. Each rubber wall 12 is vulcanization bonded to the intermediate cylinder 4 and the ring portion 9 of the fit cylinder 8, and subjected to expansion and compression attended with relative displacement of the intermediate cylinder 4 and the outer cylinder 2.

One pair of half-ring shaped orifice-forming members 15 having the orifice channel 13 along the circumferential direction in their outer peripheries are internally fitted separately in the outer cylinder between both the longitudinal walls 10 so that the orifice channel 13 may communicate with the passage 18 on the longitudinal walls side. The orifice 6 is formed in this manner. The orifice channel 13 and the passage 18 on the longitudinal walls side constitute an orifice passage. The reference numeral 14 designates an opening of the orifice 6 to the liquid chamber 5. Through the open 14, liquid is filled in or discharged from the liquid chamber 5.

Between the intermediate cylinder 4 on the rear side of the one liquid chamber 5 and the inner cylinder 1, and between the intermediate cylinder 4 on the rear side of the other liquid chamber 5 and the inner cylinder 1, there are interposed respective third rubber-like elastomer bodies 11 shorter in length in the central axis direction than the first rubber-like elastomer body 27 and the second rubber-like elastomer body 37. The third rubber-like elastomer bodies 11 are located in the middle relative to the central axis direction of the inner and outer cylinders 1, 2 and the intermediate cylinder 4. The circumferentially end portions of the third rubber-like elastomer bodies 11 join integrally with sidewalls 27A, 27B of the second rubber-like elastomer bodies 27.

One pair of sector-shaped inclination amount-limiting stoppers 16 for limiting the inclination amount of the outer cylinder 2 to the intermediate cylinder 4 are disposed separately between one end of the outer cylinder 2 outwards of the liquid chamber 5 in the central axis direction and one end of the intermediate cylinder 4, and between the other end of the outer cylinder 2 and the other end of the intermediate cylinder 4, respectively. The paired inclination amount limiting stoppers 16 are located nearly in the middle of the pair of the second rubber-like elastomer bodies 37 in the circumferential direction of the inner and outer cylinders 1, 2 and at the same time located in a point symmetry relative to the axis center of the inner and outer cylinders 1, 2.

More specifically, an arc-like groove 17 is formed in a wall part near an inner periphery of the inclination amount-limiting stopper 16, and fitted and fixed in the intermediate cylinder 4 at its one end in the central axis direction. The arc-like outer peripheral face of the inclination amount limiting stopper 16 is disposed to oppose a rubber membrane 20 vulcanization-formed on the inner peripheral face of the ring portion 9 of the fit cylinder 8 so as to be spaced apart a predetermined distance L (cf. FIG. 2). A stopper portion 19 radially outward of the arc-like groove 17 is projected inwardly of the central axis direction so as to be adjacent to the outer face of the rubber wall 12. An opposite wall face to the stopper portion 19 is situated in the nearly same position as the edge face of the outer cylinder 2 in the central axis direction.

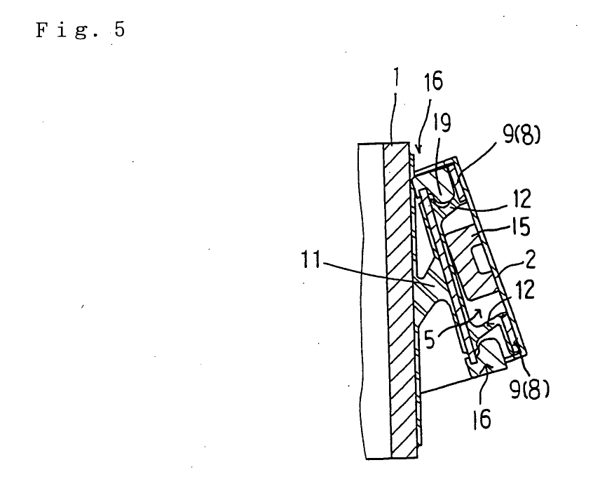

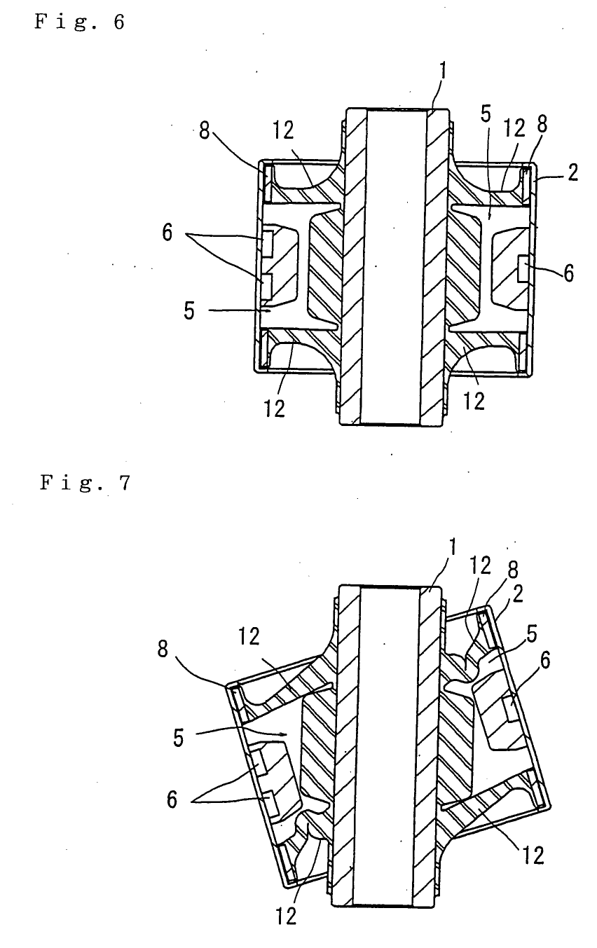

In this structure thus constructed, when the outer cylinder 2 is tilted relative to the intermediate cylinder 4, the inclination amount-limiting stopper 16 abuts on the rubber membrane 20 on the ring portion 9 side of the fit cylinder 8 as shown in FIG. 5 thereby bearing on the fit cylinder 8. As a result, it is possible to limit the inclination amount. Since the predetermined distance L is spaced apart between the inclination amount-limiting stopper 16 and the rubber membrane 20 on the ring portion 9 side of the fit cylinder 8, it is possible to deform the rubber walls 12 and the second rubber-like elastomer bodies 37 concomitantly with vibration, thereby making it possible to vary volumes of the liquid chambers 5 and to flow liquid through the orifice 6. Otherwise, the aforesaid structure may be constructed so that the outer cylinder 2 can bear the inclination amount-limiting stopper 16 instead of the fit cylinder 8.

The orifice forming member 15 functions also as a displacement amount-limiting stopper that projects from the outer cylinder 2 side in the liquid chamber 5. The orifice-forming member 15 makes it possible to prevent excessive relative displacement of the inner cylinder 1 and the outer cylinder 2, and further to limit the inclination amount of the outer cylinder 2 to the intermediate cylinder 4 by abutment of the orifice-forming member 15 on the intermediate cylinder 4.

During the fabrication process of this device, the outer cylinder 2 is subjected to crimping working in liquid, with the fit cylinder 8 housed therein. Thereby the ring portions 9 of the fit cylinder 8 are in pressure contact with the outer cylinder 2 and it is possible to fill the liquid hermetically in the liquid chambers 5. Both upper and lower ends of the outer cylinder 2 are bent radially inwardly to obstruct the relative movement of the outer cylinder 2 and the fit cylinder 8 toward the central axis direction. That is, the detachment of the outer cylinder 2 from the fit cylinder 8 is obstructed.

When vibrations input the liquid-sealed vibration-proof device as constructed above, the inner cylinder 1 and the outer cylinder 2 displace relatively, and the one pair of the first rubber-like elastomer bodies 27, the one pair of the second rubber-like elastomer bodies 37, the third rubber-like elastomer body 11, and the rubber wall 12 are subject to elastic deformation, whereby the volumes of both liquid chambers 5 change and the liquid flows through the orifice 6. As a result, a good vibration damping effect is obtainable due to liquid fluidization effect such as resonance action. In a case where the outer cylinder 2 is tilted to the inner cylinder 1 owing to the aforementioned elastic deformation, as indicated in FIG. 5, the intermediate cylinder 4 and the outer cylinder 2 are tilted integrally to the inner cylinder 1 and concurrently, the outer cylinder 2 is tilted to the intermediate cylinder 4.

Of one pair of front and rear vibration-proof devices to be mounted between a suspension member and a lower arm, the embodiments above have been described with the rear-side longitudinal installation type of liquid-sealed vibration-proof device by way of example, but this invention is so applicable to another liquid-sealed type vibration-proof devices to be mounted on other parts than the aforesaid parts. Two pairs or more of the inclination amount-limiting stoppers may be provided.

Industrial Applicability

According to this invention it is possible to provide a liquid-sealed vibration-proof device with which the lifetime of the rubber walls constituting the end walls of the liquid chambers can be lengthened.

1. A liquid-sealed type vibration-proof device, which comprises an inner cylinder; an intermediate cylinder; one pair of first rubber-like elastomer bodies situated to pinch the inner cylinder between them and interposed between the inner cylinder and the intermediate cylinder; an outer cylinder; one pair of second rubber-like elastomer bodies situated to pinch the intermediate cylinder between them and interposed between the intermediate cylinder located outside the first rubber-like elastomer bodies and the outer cylinder; one pair of liquid chambers disposed between the intermediate cylinder and the outer cylinder and in different directions from directions in which the one pair of the second rubber-like elastomer bodies are located, in a manner pinching the intermediate cylinder between them; and an orifice for bringing both liquid chambers into communication with each other;
wherein end walls of the liquid chambers relative to a central axis direction of the inner and outer cylinders are formed each of a rubber wall susceptible of expansion and compression attended by relative displacements of the intermediate cylinder and the outer cylinder;
wherein between the intermediate cylinder located on the back side of the one liquid chamber and the inner cylinder and between the intermediate cylinder located on the back side of the other liquid chamber and the inner cylinder, there are interposed respective third rubber-like elastomer bodies that are shorter in length in the central axis direction than the first rubber-like elastomer bodies and the second rubber-like elastomer bodies and integrally join, at their edges in the circumferential direction of the inner and outer cylinders, with sidewalls of the first rubber-like elastomer bodies;
wherein at least one pair of inclination amount-limiting stoppers for limiting the inclination amount of the outer cylinder to the intermediate cylinder are provided, respectively separately, between the one end of the outer cylinder outwards of the liquid chamber in the central axis direction and the one end of the intermediate cylinder, and between the other end of the outer cylinder and the other end of the intermediate cylinder.

2. The liquid-sealed type vibration-proof device as set forth in claim 1, wherein the second rubber-like elastomer bodies and the rubber walls are vulcanization formed to extend over the intermediate cylinder and a fit cylinder to the outer cylinder, the fit cylinder being internally fitted in the outer cylinder.

3. The liquid-sealed type vibration-proof device as set forth in claim 1, wherein pair of the inclination amount-limiting stoppers are provided respectively separately at both ends of the intermediate cylinder so as to be spaced apart a predetermined distance from an inner peripheral part of the outer cylinder or an inner peripheral part of the fit cylinder.

4. The liquid-sealed type vibration-proof device as set forth in claim 2, wherein one pair of the inclination amount-limiting stoppers are provided respectively separately at both ends of the intermediate cylinder so as to be spaced apart a predetermined distance from an inner peripheral part of the outer cylinder or an inner peripheral part of the fit cylinder.
